(19) United States
(12) Patent Application Publication
(10) Pub. No.: US 2006/0222013 A1
(43) Pub. Date: Oct. 5, 2006

(54) Systems, methods, and media for improving security of a packet-switched network

(76) Inventor: Oliver Keren Ban, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/093,707

(22) Filed: Mar. 30, 2005

(51) Int. Cl. H04J 3/24

(52) U.S. Cl. 370/474

(57) ABSTRACT

Systems, methods and media for improving security of a packet-switched network are disclosed. More particularly, hardware and/or software for injecting noise into a network to deter code sniffers are disclosed. One embodiment provides a method for transmitting information over a network. Embodiments may include assembling by a sender computer system one or more packets where at least one of the packets has an encrypted payload and inserting by the sender computer system Additive Gaussian White Noise into one or more of the packets. Embodiments may also include transmitting by the sender computer system the one or more packets with inserted Additive Gaussian White Noise over a network. Further embodiments may include inserting Additive Gaussian White Noise into a packet containing encrypted payload. Other further embodiments may include inserting Additive Gaussian White Noise into an Addtive Gaussian White Noise packet.

### FIELD OF INVENTION

The present invention is in the field of computer systems. More particularly, the present invention relates to systems, methods and media for improving security of a packet-switched network, particularly for injecting noise into a network to deter code sniffers.

### BACKGROUND

Personal computers (PCs) and other computer systems have also become increasingly connected by networks such as the Internet, intranets, Wide Area Networks (WANs), and Local Area Networks (LANs). Networks such as the Internet and corporate intranets provide a mechanism for users to transfer data among computers for information sharing, workplace collaboration, data collection, etc. Users gain access to networks such as the Internet by accessing a web server via personal Internet service providers (ISP's), broadband network connections, or high speed network connections through office systems. Networks require a protocol for specifying an agreed-upon format for transmitting data between two devices which facilitates communication between computers within the network and on other networks. Most modern Wide Area Network (WAN) protocols, such as the Transfer Control Protocol/Internet Protocol (TCP/IP), are based on packet switching technologies. Packet switching refers to protocols in which messages are divided into packets before they are sent. Each packet is then transmitted individually and can follow different routes to its destination. Once all the packets forming a message arrive at the destination, they are recompiled into the original message. IP allows for routing of packets of data (including both data and a header) from node to node, forwarding data packets based on a four byte destination address (the IP number). TCP creates a reliable communications stream on top of the somewhat unreliable packet IP (called TCP/IP when they are combined). TCP adds support to detect errors or lost data and to trigger retransmission until data is correctly and completely received. TCP treats data as a stream of bytes that includes a header that designates a starting byte and a size, allowing the receiver to detect missing or incorrectly sequenced packets.

Users are increasingly relying on networks to transfer confidential data between computer systems. Users are, for example, increasing their usage of networks to purchase goods and services via electronic commerce (e-commerce) solutions, necessitating the transfer over the network of sensitive credit card and purchase information. Many individuals and companies, in another example, desire to communicate via private e-mails, transfer funds electronically, pay taxes electronically, or the like. Other industries and professions, such as banks and other financial institutions, also increasingly rely on the confidentiality of electronic communications. As electronic commerce and communication become more ubiquitous, the need for secure network communications will only increase.

Hackers have taken advantage of the increase in network communications by developing methods of improperly capturing network communications. One hacker methodology utilizes sniffers, which are programs or devices that monitor data traveling over the network. A sniffer typically must be located in between the sender and receiver on the network. Unauthorized sniffers (also known as code sniffers) can be dangerous to a network's security as they are very difficult to detect and can be inserted almost anywhere within the network. When sniffers are used to sniff packets in a TCP/IP or other packet-switched network they are also called packet sniffers. Using a packet sniffer, a hacker can capture a packet, decode the binary code of the packet, and thus access its contents. If a packet contains sensitive information such as a password or credit card information, such access can be extremely damaging to the devices communicating on the network. As a packet sniffer is capable of capturing all packets traversing the network regardless of destination, the damage can also be widespread.

Detecting packet sniffers is not an easy task, partially because of the passivity of packet sniffers while it captures packets traveling through a network interface it is monitoring. Because packet sniffers are difficult to detect, network administrators attempt to deter sniffers from being used in the first place by making the task of accessing information in the packets more difficult. To combat hackers using packet sniffers, for example, network administrators often encrypt the packets being transmitted over the network. Encrypted packets make it more difficult for sniffers to access the information in a captured packet as the sniffer would have to decrypt the packet in order to access the information inside. To access an entire message, each packet constituting that message would have to be decrypted. Decryption requires significant processing power by the hacker or sniffer to break the encryption, particularly when using brute force decryption. Decryption may be made easier, however, by analyzing a series of packets for patterns used in the encryption, resulting in reduced processing time and resources necessary to break the encryption. While encryption does increase the difficulty of successfully using packet sniffers, it does not prevent their successful use and results in an increased security risk. Encryption of packets on a network does not, therefore, provide a complete and satisfactory solution to hackers using packet sniffers or other techniques to access sensitive data on a network.

There is, therefore, a need for an effective mechanism for improving security on a packet-switched network. There is an even greater need for such a system when sensitive information is being used on a network and hackers may be placing sniffers on the network.

### SUMMARY OF THE INVENTION

The problems identified above are in large part addressed by systems, methods and media for improving security of a packet-switched network. One embodiment provides a method for transmitting information over a network. Embodiments may generally include assembling by a sender computer system one or more packets based on the information to be transmitted where at least one of the one or more packets has an encrypted payload comprising the information to be transmitted. Embodiments may also generally include inserting by the sender computer system Additive Gaussian White Noise into one or more of the packets. Embodiments may also generally include transmitting by the sender computer system the one or more packets with inserted Additive Gaussian White Noise over the network. Further embodiments may include inserting Additive Gaussian White Noise into a packet containing encrypted payload. Other further embodiments may include inserting Additive Gaussian White Noise into an Additive Gaussian White Noise packet.

Another embodiment provides a machine-accessible medium containing instructions effective, when executing in a data processing system, to cause the system to perform a series of operations for synchronizing a database on a network. The series of operations generally includes assembling by a sender computer system one or more packets based on the information to be transmitted where at least one of the one or more packets has an encrypted payload comprising the information to be transmitted. The series of operations may also generally include inserting by the sender computer system Additive Gaussian White Noise into one or more of the packets. The series of operations may also generally include transmitting by the sender computer system the one or more packets with inserted Additive Gaussian. White Noise over the network. Further embodiments may include inserting Additive Gaussian White Noise into a packet containing encrypted payload. Other further embodiments may include inserting Additive Gaussian White Noise into an Additive Gaussian White Noise packet.

A further embodiment provides a system for transmitting information over a network. The system may generally include a TX unit for facilitating transmission of the information to a receiver computer system via the network and a packet module of the TX unit for breaking the information to be transmitted into one or more packets. The system may also generally include an Additive Gaussian White Noise module in communication with the packet module for inserting Additive Gaussian White Noise into one or more of the packets. The system may further include Additive Gaussian White Noise storage in communication with the Additive Gaussian White Noise module for storing Additive Gaussian White Noise. The packets may include in one embodiment one or more blocks of encrypted payload and one or more blocks of Additive Gaussian White Noise. In another embodiment, one or more of the packets may be an Additive Gaussian White Noise packet.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an environment for a system for transmitting information from a sender computer system to a receiver computer system according to one embodiment;

FIG. 2 depicts an example of a flow chart for transmitting information via a bit stream and inserting AGWN noise packets into the bit stream according to one embodiment;

FIG. 3 depicts an example of a flow chart for receiving and decoding information via a bit stream according to one embodiment;

FIG. 4 depicts an example of a flow chart for transmitting information in a packet and inserting AGWN noise into the packet according to one embodiment;

FIG. 5 depicts an example of a flow chart for receiving and decoding a packet of information according to one embodiment; and

FIG. 6 depicts an assembled packet with embedded AGWN noise according to one embodiment.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for improving security of a packet-switched network are disclosed. More particularly, hardware and/or software for injecting noise into a network to deter code sniffers are disclosed. One embodiment provides a method for transmitting information over a network. Embodiments may include assembling by a sender computer system one or more packets where at least one of the packets has an encrypted payload and inserting by the sender computer system Additive Gaussian White Noise into one or more of the packets. Embodiments may also include transmitting by the sender computer system the one or more packets with inserted Additive Gaussian White Noise over a network. Further embodiments may include inserting Additive Gaussian White Noise into a packet containing encrypted payload. Other further embodiments may include inserting Additive Gaussian White Noise into an Additive Gaussian White Noise packet.

The disclosed embodiments provide a methodology and system for improving the security of a packet-switched network condition by inserting Additive Gaussian White Noise into a bit stream. By inserting Additive Gaussian White Noise into one or more packets being transmitted over a network, any unauthorized sniffers will be thwarted in their attempts to decrypt information on the network. Sniffers relying on pattern recognition to decrypt encrypted packets of information will be confused by the Additive Gaussian White Noise and will be therefore unable to access the information inside the packet. As Additive Gaussian White Noise will appear to a sniffer to be substantially similar to normal encrypted payloads, the sniffers will have difficulty determining which packets are encrypted and which packets are noise. The methodology and system of the disclosed embodiments accordingly provide improved security of information being transmitted on a network.

While specific embodiments will be described below with reference to particular configurations of hardware and/or software, those of skill in the art will realize that embodiments of the present invention may advantageously be implemented with other substantially equivalent hardware and/or software systems.

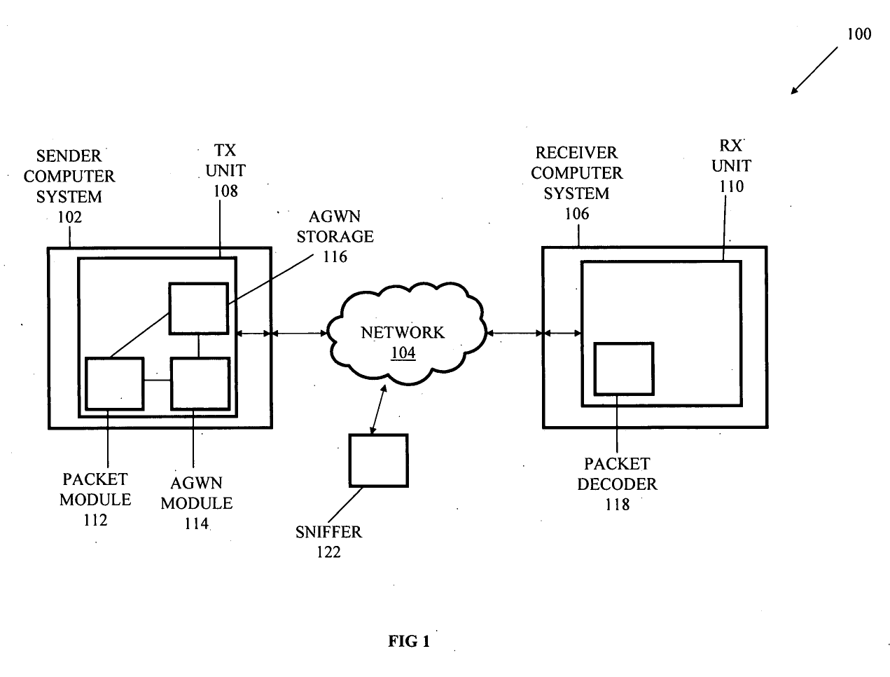

Turning now to the drawings, FIG. 1 depicts an environment for a system for transmitting information from a sender computer system to a receiver computer system according to one embodiment. In the depicted embodiment, the packet network system 100 includes one or more sender computer systems 102 in communication with a network 104. The packet network system 100 may also include one or more receiver computer systems 106 in communication with the network 104. The sender computer system 102 may transmit information (such as in the form of packets) to the receiver computer system 106 via network 104. A particular computer system may serve as both a sender computer system 102 (and transmit information to a receiver computer system 106) and a receiver computer system 106 (and receive information from a sender computer system 102) in one embodiment, such as when two computer systems are transmitting information back and forth between them.

Sender computer system 102 and/or receiver computer system 106 may be one or more of a personal computer, workstation, server, mainframe computer, notebook or laptop computer, tablet PC, desktop computer, portable computer system, PDA, set-top box, mobile phone, wireless device, or the like. The sender computer system 102 and/or receiver computer system 106 may, in one embodiment, include a central processing unit (CPU) and associated volatile and non-volatile memory, including random access memory (RAM) and basic input/output system read only memory (BIOS ROM), a system monitor, a keyboard, one or more flexible diskette drives, a CD-ROM drive, a fixed disk storage drive (also known as a “hard drive” or “hard disk drive”), a pointing device such as a mouse, and an optional network interface adapter, all electrically connected using a motherboard or system planar to electrically connect these components together. In one embodiment, the sender computer system 102 and/or the receiver computer system 106 may be an International Business Machine Corporation (IBM®) eServer or similar server having one or more processors, or threads of processors, executing software and/or one or more state machines coupled with data storage devices such as RAM, read only memory (ROM), flash memory, compact disk drives, hard drives, and the like. In another embodiment, the sender computer system 102 and/or the receiver computer system 102 may be personal computer systems such as IBM's® PC 300, ThinkCentre, ThinkPad, Aptiva, and IntelliStation series of personal computers. The sender computer system 102 and the receiver computer system 106 may be located at the same location, such as in the same building or computer lab, or could be remote. While the term “remote” is used with reference to the distance between the sender computer system 102 and the receiver computer system 106, the term is used in the sense of indicating separation of some sort, rather than in the sense of indicating a large physical distance between the systems.

Network 104 may be any type of wired or wireless data communications channel, such as the Internet, an intranet, a LAN, a WAN, an Ethernet network, a wireless network, etc. In one embodiment, network 104 utilizes the TCP/IP protocols or other packet-based protocols. Those skilled in the art will recognize, however, that the invention described herein may be implemented utilizing any type of data communications channel.

A hacker may position a sniffer 122 within (or in communication with) network 104 so that the sniffer 122 may capture packets or other information being transmitted within the packet network system 100. In previous systems, a sniffer 122 could capture transmitted packets and access the information contained within them. In the event the captured packets were encrypted, the sniffer 122 could potentially decrypt the packets. While decryption can take a significant amount of resources to break the encryption, the task can be made easier by looking for patterns in a packet or series of packets using a pattern recognizer. These patterns can provide an indication of the encryption method used and thus makes it easier, and less resource-intensive, to decrypt. In the system of the disclosed embodiments, the sender computer system 102 may add or inject one or more elements of Additive Gaussian White Noise (AGWN) to one or more of the packets, as described in more detail subsequently. When a sniffer 122 captures an AGWN-injected packet, it will treat the AGWN-injected packet as if it were a typical payload packet. Because the AGWN-injected packet has a different pattern than an encrypted packet (being generated noise), it will assist in fooling or confusing the sniffer 122. The sniffer 122 is thus likely confused by the different pattern of the AGWN-injected portions, substantially thwarting attempts to decrypt the packet.

AGWN, which is also known as Additive White Gaussian Noise (AWGN) or white noise or thermal noise, may be noise that has a frequency spectrum that is continuous and uniform over a specified frequency band. AGWN may be created by drawing random numbers from a Gaussian distribution (also known as a bell curve) and adding the noise to a signal. AGWN may be particularly suited for the system of the disclosed embodiments as it will appear to sniffers 122 as an encrypted payload packet. By being substantially indistinguishable from normal encrypted packets, the AGWN-injected packet may confuse the pattern recognizer of the sniffer 122 and thus protect the security of the information within the packet.

The sender computer system 102 may include a TX unit 108, which itself may include a packet module 112, an AGWN module 114, and an AGWN storage 116. The TX unit 108 may facilitate transmission of information from the sender computer system 102 via network 104. The packet module 112 of the TX unit 108 may create or receive information to be transmitted and break the information into one or more packets for transmittal over network 104 to the receiver computer system 106. The number, type and configuration of packets created by packet module 112 depend on the protocol used by the sender computer system 102 and the network 104.

The AGWN module 114 may, either solely or in conjunction with the packet module 112, add AGWN to one or more of the packets. The AGWN module 114 may generate the noise as needed or access previously generated AGWN noise, such as in the AGWN noise storage 116. In one embodiment, the AGWN module 114 of the TX unit 108 may generate a series of AGWN noise and fit the noise into a management demon and store the management demon in AGWN storage 116. The AGWN module 114 may generate a locally generated representation of noise which may differ from noise generated by other systems. Generated AGWN noise may have associated size, duration, or strength information. In another embodiment, the AGWN module 114 may generate AGWN noise whenever needed, eliminating the need for AGWN storage 116.

In one embodiment, the AGWN module 114 may add one or more blocks of AWGN to the payload portion of a particular packet. This embodiment may be useful under any type of protocol, such as when the packet module 112 breaks information into multiple packets, single packets, etc. In this embodiment, the packet may then include header information as well as one or more blocks of payload information intermixed with one or more blocks of AGWN. By including AGWN with payload information, a sniffer 122 capturing the packet would attempt to decrypt the packet using both the AGWN and payload packets, drastically reducing the ability for the sniffer 122 to determine encryption patterns necessary to make the decryption process feasible.

In another embodiment (particularly useful when the packet module 112 breaks information into a plurality of packets), the payload in particular packets may be replaced with AGWN, so that the bit stream between the sender computer system 102 and the receiver computer system 106 may include both payload packets and AGWN packets. In this embodiment, a sniffer 122 would capture a series of packets (both payload and AGWN packets) and attempt to analyze the series for patterns so that the packets could be encrypted. Any AGWN packets would confuse the sniffer 122 and possibly foil any attempts at decrypting the packets. As an AGWN packet appears to be a standard payload packet, the sniffer 122 may not be alerted to the presence of the AGWN packet. These two embodiments may also be combined by the AGWN module 114 creating AGWN packets as well as packets containing payload and AGWN blocks to further confuse any sniffers 122.

The packets transmitted over network 104 may be received by the RX unit 110 of the receiver computer system 106. The RX unit 110 may itself include a packet decoder 118. The packet decoder 118 may decode each received packet (using a codebook or key previously acquired). After decoding the received packets, the packet decoder 118 may discard or ignore any AGWN packets or packet blocks. Only after decoding the received packets will the packet decoder 118 know which packets or parts of packets are AGWN. As an unauthorized sniffer 122 does not have the codebook, it likely cannot determine the existence or location of AGWN noise.

The system of the disclosed embodiments provides an effective mechanism for preventing sniffers 122 from successfully capturing information transmitted over network 104. By inserting AGWN into the bit stream (either as entire packets or as part of a packet), attempts by a sniffer 122 to decrypt the packets are made much more difficult as the AGWN effectively ‘jams’ its pattern recognition functions. Because the pattern recognition functions are jammed, the sniffer 122 must rely on brute force decryption techniques, making it very ineffective and resource-intensive to attempt to access information being transmitted over network 104.

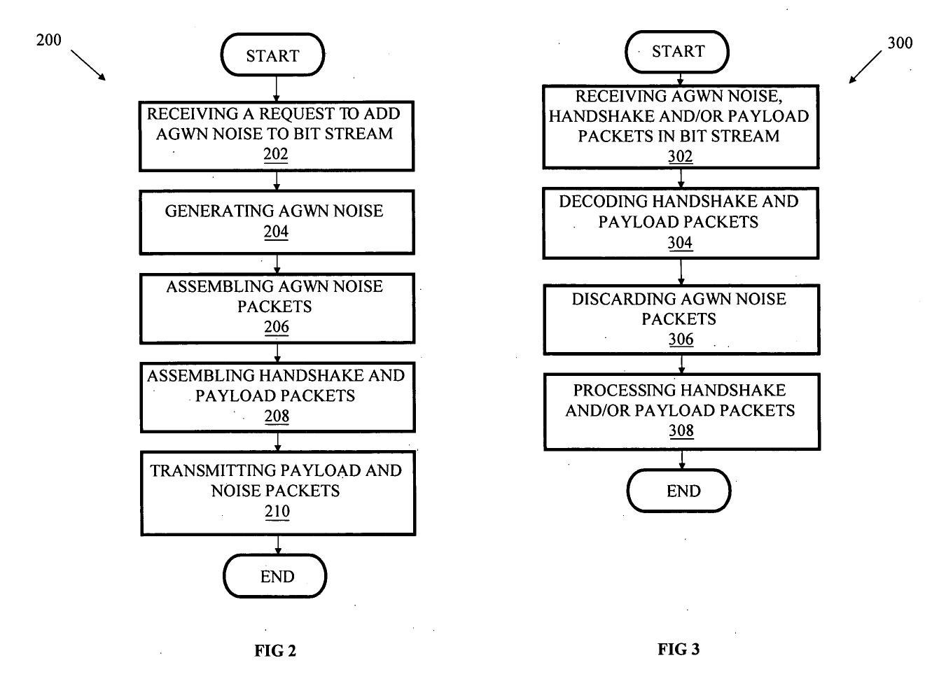

FIG. 2 depicts an example of a flow chart for transmitting information via a bit stream and inserting AGWN noise packets into the bit stream according to one embodiment. The method of flow chart 200 may be performed, in one embodiment, by components of the TX unit 108 of the sender computer system 102. Flow chart 200 begins with optional element 202, receiving a request to add AGWN noise to a bit stream. The bit stream may represent the digital stream of information passing from the sender computer system 102 to the receiver computer system 106 via network 104. At element 202, the TX unit 108 may receive a request to add AGWN noise to a bit stream from any source, such as another component of the sender computer system 102. In an alternative embodiment, the TX unit 108 (or one of its components) may generate a request to add AGWN noise to a bit stream instead of receiving a request, such as in response to detecting a sniffer 122 accessing network 104. In another alternative embodiment, the TX unit 108 (or its components) may add AGWN noise to a bit stream automatically so that all communications over network 104 receive the protection of added AGWN noise. For example, automatic addition of AGWN noise may prove advantageous for a wireless network where detection of sniffers may be particularly difficult. A user or network administrator may, in one embodiment, configure the operation of the TX unit 108 to specify how and when AGWN noise might be added to the bit stream.

Flow chart 200 continues to optional element 204, generating AGWN noise. In one embodiment, the AGWN module 114 of the TX unit 108 may generate a series of AGWN noise for eventual insertion into the bit stream. In an alternative embodiment, the AGWN module 114 may generate the AGWN noise before the start of flow chart 200 and store the AGWN noise in a management demon located in the AGWN noise storage 116. In this embodiment, the packet module 112 or AGWN module 114 may access the AGWN noise storage 116 to retrieve the AGWN noise.

After acquiring AGWN noise (such as by generating or retrieving it), the AGWN module 114 may assemble one or more AGWN noise packets using the AGWN noise at element 206. Similarly, the packet module 112 may also assemble any handshake and/or payload packets at element 208. In this embodiment, the packet module 112 may assemble the handshake and/or payload packets in the same fashion as if AGWN noise was not being inserted. For example, the packet module 112 may break information to be transmitted into multiple payload packets, each with header information, and also assemble handshake packets as required for the network connection with the receiver computer system 106.

The AGWN noise packets created by the AGWN module 114 may advantageously be the same size as any payload packets created by the packet module 112. A sniffer 122 will be less likely to be able to differentiate between an AGWN noise packet and a payload packet if they are the same size.

Once the AGWN noise packets, handshake, and/or payload packets have been assembled, flow chart 200 continues to element 210, transmitting the packets over network 104 to the receiver computer system 106, after which the flow chart terminates. In one embodiment, the TX unit 108 may transmit the packets by inserting the packets into the bit stream. The TX unit 108 may transmit the handshake, payload, and AGWN noise packets in any order. The TX unit 108 may advantageously randomly vary the order of transmission of the payload and AGWN noise packets to make it more difficult for any sniffers 122 to discern or guess which ones might be AGWN noise packets. By randomly inserting AGWN noise packets into the bit stream in between legitimate payload packets, most attempts by sniffers 122 to decrypt the payload packets will be thwarted as the AGWN noise packets will fool the sniffers 122 and disrupt their pattern recognition algorithms.

FIG. 3 depicts an example of a flow chart for receiving and decoding information via a bit stream according to one embodiment. The method of flow chart 300 may be performed, in one embodiment, by components of the RX unit 110 of the receiver computer system 106. Flow chart 300 begins with element 302, receiving one or more AGWN noise, handshake, and/or payload packets in a bit stream from the sender computer system 102 via network 104. As described in relation to FIG. 2, the RX unit 110 may receive the AGWN noise, handshake, and/or payload packets in any order.

After receiving the packets, flow chart 300 continues to element 304, decoding the handshake and/or payload packets. The packet decoder 118 of the RX unit 110 may perform element 304 by using a key or codebook to assist in decoding. Once the packets have been decoded by the packet decoder 118, the information within the packets may then be accessed. Unauthorized sniffers 122 do not have a key or codebook and thus are unable to decode the packets. AGWN noise packets cannot be decoded by the packet decoder 118, even when they have a key or codebook, as they are not encrypted. If the packet decoder 118 determines that a particular packet cannot be decoded, the packet decoder 118 may assume that the packet is an AGWN noise packet and may then discard the AGWN noise packet at element 306. In this situation, discarding the AGWN noise packet may represent deleting, ignoring, tagging, or otherwise treating the AGWN noise packet differently than a decoded payload packet.

Once the payload and/or handshake packets have been decoded by the packet decoder 118, the packet decoder 118 may pass the decoded packets off to another component of the receiver computer system 106 for further processing at element 308, after which the flow chart terminates. For example, the packet decoder 118 may pass the packets to a software module (such as a browser, file transfer, e-mail program, or the like) for processing or handling.

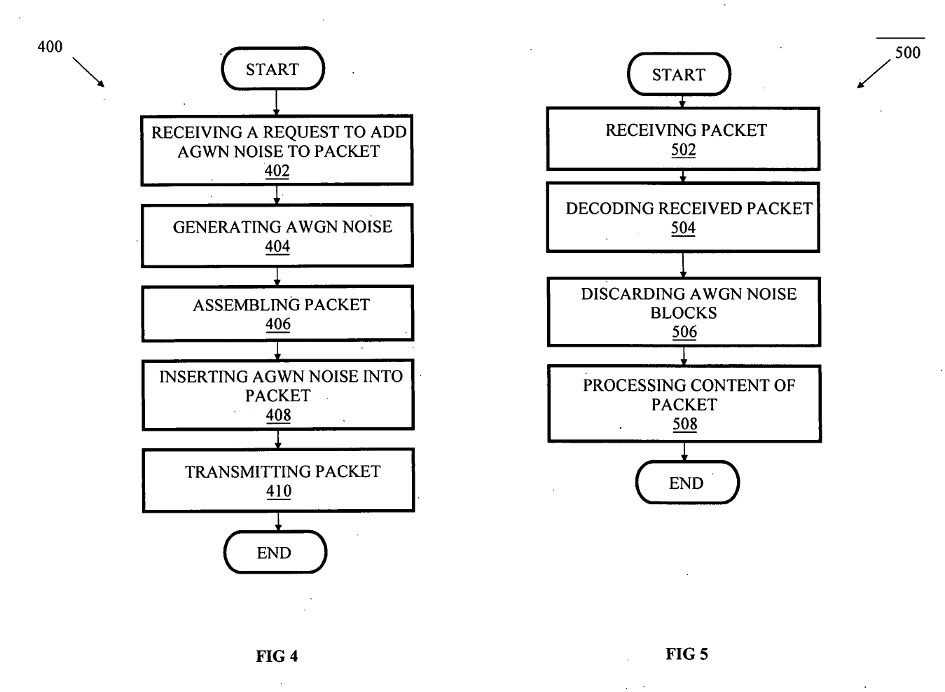

FIG. 4 depicts an example of a flow chart for transmitting information in a packet and inserting AGWN noise into the packet according to one embodiment. The method of flow chart 400 may be performed, in one embodiment, by components of the TX unit 108 of the sender computer system 102. Flow chart 400 begins with optional element 402, receiving a request to add AGWN noise to a packet. The packet may be one of a group of packets used to transmit information from the sender computer system 102 to the receiver computer system 106. At element 402, the TX unit 108 may receive a request to add AGWN noise to a packet from any source, such as another component of the sender computer system 102. In an alternative embodiment, the TX unit 108 (or one of its components) may generate a request to add AGWN noise to a packet instead of receiving a request, such as in response to detecting a sniffer 122 accessing network 104. In another alternative embodiment, the TX unit 108 (or its components) may add AGWN noise to a packet automatically so that all communications over network 104 receive the protection of added AGWN noise. A user or network administrator may, in one embodiment, configure the operation of the TX unit 108 to specify how and when AGWN noise might be added to the packet.

Flow chart 400 continues to optional element 404, generating AGWN noise. In one embodiment, the AGWN module 114 of the TX unit 108 may generate a series of AGWN noise for eventual insertion into the bit stream. In an alternative embodiment, the AGWN module 114 may generate the AGWN noise before the start of flow chart 400 and store the AGWN noise in a management demon located in the AGWN noise storage 116. In this embodiment, the packet module 112 or AGWN module 114 may access the AGWN noise storage 116 to retrieve the AGWN noise.

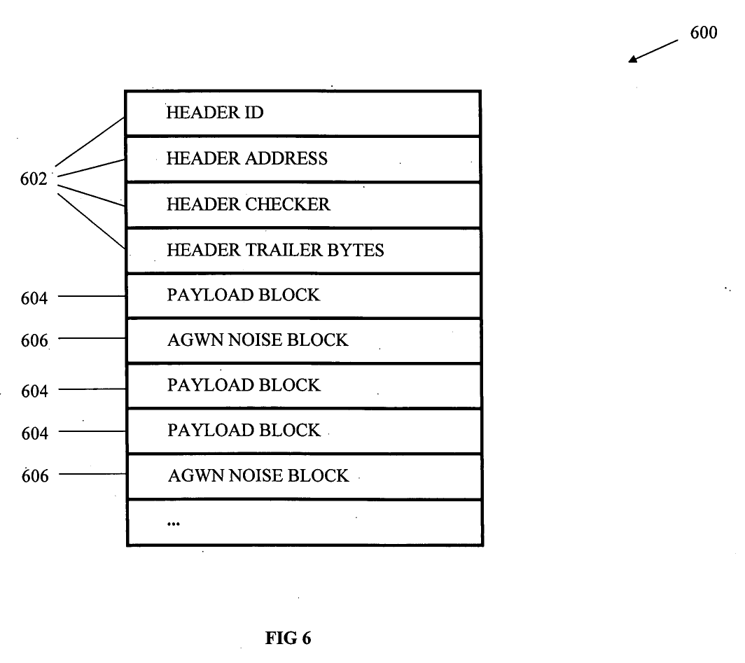

After acquiring AGWN noise (such as by generating or retrieving it), the packet module 112 of the TX unit 108 may assemble the packet at element 406. Assembly of the packet may include encryption of all or part of the packet. The packet module 112 may designate or create one or more blocks or other designated areas for insertion of AGWN noise. At element 408, the AGWN module 114 may insert AGWN noise into the designated noise areas (blocks) of the packet. Alternatively, the packet module 112 (possibly working in conjunction with the AGWN module 114) may insert the AGWN noise into the packet itself, such as by performing elements 406 and 408 simultaneously. The packet may include heading information, payload areas, and noise areas arranged in any fashion. One embodiment of a suitable packet is described in relation to FIG. 6.

In one embodiment, the packet may include one or more blocks that include payload and one or more blocks that include AGWN noise. A sniffer 122 capturing such a packet may attempt to search the different the entire packet for patterns that indicate what type of encryption was performed on the packet. When such a sniffer 122 analyzes a normal encrypted packet without inserted AGWN noise, it may be able to detect patterns in the contents of the packet and thus be able to more easily decrypt the packet. When the packet contains one or more AGWN blocks, the sniffer 122 will likely be unable to detect any patterns in the contents of the packet and will thus be fooled.

Once the packet with AGWN noise has been assembled, flow chart 400 continues to element 410, transmitting the packet over network 104 to the receiver computer system 106, after which the flow chart terminates. In one embodiment, the TX unit 108 may transmit the packet by inserting it into the bit stream.

FIG. 5 depicts an example of a flow chart for receiving and decoding a packet of information according to one embodiment. The method of flow chart 500 may be performed, in one embodiment, by components of the RX unit 110 of the receiver computer system 106. Flow chart 500 begins with element 502, receiving a packet from the sender computer system 102 via network 104. After receiving the packet, flow chart 500 continues to element 504, decoding the packet. The packet decoder 118 of the RX unit 110 may perform element 504 by using a key or codebook to assist in decoding. Once the packet has been decoded by the packet decoder 118, the information within the packets may then be accessed. If the packet decoder 118 determines that a particular block of data cannot be decoded, the packet decoder 118 may assume that the block is a block of AGWN noise. Any blocks of AGWN noise packet may then be discarded at element 506.

Once the packet has been decoded by the packet decoder 118 and the AGWN noise discarded, the packet decoder 118 may pass the decoded packet off to another component of the receiver computer system 106 for further processing at element 508, after which the flow chart terminates. For example, the packet decoder 118 may pass the packets to a software module (such as a browser, file transfer, e-mail program, or the like) for processing or handling.

FIG. 6 depicts an assembled packet with embedded AGWN noise according to one embodiment. Packet 600 may be assembled by a TX unit 108 of a sender computer system 102 for transmittal to a receiver computer system 106 via network 104. In the depicted embodiment, packet 600 is a modified payload packet with header information. Packet 600 may include one or more header blocks 602, one or more payload blocks 604, and one or more AGWN noise blocks 606. The one or more header blocks 602 may include header identifiers, addresses, checkers, or trailer bytes and are known in the art. Header blocks 602 may be encoded. The configuration of the packet 600 depicted in FIG. 6 is only one possible configuration of a packet 600 and one skilled in the art will recognize that many alternative configurations are possible.

Payload blocks 604 may include the information to be transmitted and may also be encoded. AGWN noise blocks 606 may include noise inserted into packet 600 at element 408 of flow chart 400 of FIG. 4. Payload blocks 604 and AGWN noise blocks 606 may be arranged in any fashion. A random arrangement of payload blocks 604 and AGWN noise blocks 606 makes it even more difficult for sniffers 122 to access the information encoded in the payload blocks 604 as the sniffer 122 will not know which blocks are AGWN noise blocks. In one example, a single AGWN noise block 606 may be placed among a plurality of payload blocks 604. This example provides a minimum of bandwidth being dedicated to non-payload options but may be easier for a sophisticated sniffer 122 to attempt to determine patterns. In another example, a plurality of AGWN noise blocks 606 may be added to the packet 600 and distributed throughout to make it more difficult for even the most sophisticated sniffers 122 to decrypt the packet 600. In this example, the number and location of AGWN noise blocks 606 may be randomly varied between packets 600 to increase security.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for improving security of a packet-switched network. It is understood that the form of the invention shown and described in the detailed description and the drawings are to be taken merely as examples. It is intended that the following claims be interpreted broadly to embrace all the variations of the example embodiments disclosed.

What is claimed is:

1. A method for transmitting information over a network, the method comprising:
assembling by a sender computer system one or more packets based on the information to be transmitted, at least one of the one or more packets having an encrypted payload comprising the information to be transmitted;
inserting by the sender computer system Additive Gaussian White Noise into one or more of the packets; and
transmitting by the sender computer system the one or more packets with inserted Additive Gaussian White Noise over the network.

2. The method of claim 1, further comprising receiving a request to transmit the information to a receiver computer system.

3. The method of claim 1, further comprising generating a request to transmit the information to a receiver computer system.

4. The method of claim 1, further comprising generating Additive Gaussian White Noise.

5. The method of claim 1, wherein inserting Additive Gaussian White Noise into one or more of the packets comprises inserting Additive Gaussian White Noise into a packet containing encrypted payload.

6. The method of claim 1, wherein inserting Additive Gaussian White Noise into one or more of the packets comprises inserting one or more blocks of Additive Gaussian White Noise randomly into a packet containing one or more blocks of encrypted payload.

7. The method of claim 1, wherein inserting Additive Gaussian White Noise into one or more of the packets comprises inserting Additive Gaussian White Noise into a Additive Gaussian White Noise packet.

8. A machine-accessible medium containing instructions effective, when executing in a data processing system, to cause said data processing system to perform operations comprising:
assembling by a sender computer system one or more packets based on the information to be transmitted, at least one of the one or more packets having an encrypted payload comprising the information to be transmitted;
inserting by the sender computer system Additive Gaussian White Noise into one or more of the packets; and
transmitting by the sender computer system the one or more packets with inserted Additive Gaussian White Noise over the network.

9. The machine-accessible medium of claim 8, further comprising receiving a request to transmit the information to a receiver computer system.

10. The machine-accessible medium of claim 8, further comprising generating a request to transmit the information to a receiver computer system.

11. The machine-accessible medium of claim 8, further comprising generating Additive Gaussian White Noise.

12. The machine-accessible medium of claim 8, wherein inserting Additive Gaussian White Noise into one or more of the packets comprises inserting Additive Gaussian White Noise into a packet containing encrypted payload.

13. The machine-accessible medium of claim 8, wherein inserting Additive Gaussian White Noise into one or more of the packets comprises inserting one or more blocks of Additive Gaussian White Noise randomly into a packet containing one or more blocks of encrypted payload.

14. The machine-accessible medium of claim 8, wherein inserting Additive Gaussian White Noise into one or more of the packets comprises inserting Additive Gaussian White Noise into a Additive Gaussian White Noise packet.

15. A sender computer system for transmitting information over a network, the system comprising:
a TX unit, the TX unit being adapted to facilitate transmission of the information to a receiver computer system via the network;
a packet module of the TX unit, the packet module being adapted to break the information to be transmitted into one or more packets; and
an Additive Gaussian White Noise module in communication with the packet module, the Additive Gaussian White Noise module being adapted to insert Additive Gaussian White Noise into one or more of the packets.

16. The system of claim 15, further comprising Additive Gaussian White Noise storage in communication with the Additive Gaussian White Noise module, the Additive Gaussian White Noise storage being adapted to store Additive Gaussian White Noise.

17. The system of claim 15, wherein at least one of the packets includes one or more blocks of encrypted payload and one or more blocks of Additive Gaussian White Noise.

18. The system of claim 15, wherein at least one of the packets is an Additive Gaussian White Noise packet.

19. The system of claim 15, wherein the Additive Gaussian White Noise module is further adapted to generate Additive Gaussian White Noise.

20. The system of claim 15, wherein the Additive Gaussian White Noise module is further adapted to randomly insert Additive Gaussian White Noise into encrypted payload packets.
